(19) United States
(12) Patent Application Publication
(10) Pub. No.: US 2008/0191623 A1
(43) Pub. Date: Aug. 14, 2008

(54) Halogen Lamp

(75) Inventors: Bernd Schonfelder, Aachen (DE); Martin Hanek, Baesweiler (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,234

(22) PCT Filed: Jul. 13, 2005
(86) PCT No.: PCT/IB05/52321

§ 371 Date: Jan. 17, 2007

(30) Foreign Application Priority Data
Jul. 22, 2004 (EP) 04103505.6

(51) Int. Cl. B60Q 1/04; H01K 1/50

(52) U.S. Cl. 313/570; 313/637; 313/578

(57) ABSTRACT

A halogen lamp is described that is intended in particular for at least one mode of operation at a lamp voltage substantially below the nominal voltage or a lamp power substantially below the nominal power or that is intended for switching between a first such mode of operation and a second, normal mode of operation in which the lamp is operated substantially at its nominal voltage or power. To prevent, in the first mode of operation, any increased mass transport of molybdenum and, as a result of this, possible blackening of the envelope of the lamp or growth of whiskers in the region of the legs of the incandescent filament or of the first turns of the incandescent filament, use is made of a bromine-free filling gas that has chlorine. Lamps of this kind are used for example in the headlights of motor vehicles for what is termed daylight running (DRL=daylight running light).

The invention relates to a halogen lamp that is intended in particular for at least one mode of operation at a lamp voltage substantially below the nominal voltage or at a lamp power substantially below the nominal power or that is intended for switching between a first such mode of operation and a second, normal mode of operation in which the lamp is operated substantially at its nominal voltage or power. Lamps of this kind are used for example in the headlights of motor vehicles.

The lamps intended for the headlights of motor vehicles are preferably intended to be capable of being operated in a first mode of operation for driving in daylight (DRL—daylight running light) and in a second mode of operation for driving at night (normal mode of operation). The purpose of the first mode of operation in this case is, in essence, only to improve the visibility of the vehicle to other road users, whereas in the second mode of operation the intention is to ensure that, by using the usual dipped and main beams, the driver can see the carriageway properly.

For this reason, in the first mode of operation the lamp only needs to be operated at a lamp voltage that is substantially below its nominal voltage, or at a lamp power which is substantially below its nominal power. How far the values in question may actually be below the nominal voltage or nominal power is decided in the light of the requirements of the application concerned or of the relevant codes or standards (see, amongst others, SAE standard J 2087).

For a halogen lamp having a nominal voltage of approximately 13 to 14 volts that is intended for use in a motor vehicle, the lamp voltage is reduced in the said first mode of operation to a value of, for example, between approximately 5 and 6 volts (i.e. by about 50%) or to a value of approximately 10 volts.

However, in practice it has been found that, with halogen lamps that have molybdenum lead wires inside the lamp, the envelope of the lamp becomes blackened after a certain number of hours in operation have elapsed in the said first mode of operation. This effect occurs to a particularly marked degree if frequent changes are made between the first mode of operation and the second, normal mode of operation (“changeover operation”).

If however operation takes place predominantly or substantially exclusively in the first mode of operation (i.e. if the vehicle is driven mainly in daylight), what is also observed is a relatively heavy growth of whiskers in the region of the legs of the incandescent filament or in the region of its first turns.

What is more, it is also observed that in the first and second modes of operation, the molybdenum supply wires are subject to relatively heavy attack and to erosive phenomena.

These effects are all the more pronounced, the lower the level at which the effective lamp voltage is set in the first mode of operation in comparison with the nominal voltage. What is more, it has been found that when used in practice in a motor vehicle, even in changeover operation, the actual working life of a lamp of this kind is generally substantially longer in the first mode or operation than in the second one, as a result of which the problems outlined above become even more serious.

It is true that it has been found that the extent of the blackening can be reduced by setting the amount of oxygen in the glass envelope in a suitable way. However, this amount of oxygen has to be very precisely observed in the envelope of the lamp with the help of getter materials. This means that the production of the lamp is relatively complicated and hence expensive.

Known from JP OS 07-296783 is a halogen lamp for use in the headlights of motor vehicles that is intended for switching between a first mode of operation at a low lamp voltage and a second mode of operation at a high lamp voltage. Blackening of the envelope of the lamp in the first mode of operation is substantially prevented in this case by virtue of the fact that the lead wires that run to the incandescent filament inside the envelope of the lamp are produced in essence from tantalum and the filling gas contained in the envelope of the lamp is a mixture of krypton, bromine and chlorine. However, a disadvantage in this case is once again that the lamps are relatively expensive.

It is therefore an object of the invention to provide a halogen lamp in which the above-mentioned problems do not occur, or at least occur only to a substantially smaller extent, and which can be operated in particular in the first mode of operation or in changeover operation without any substantial blackening of the envelope of the lamp occurring during the normal working life of the lamp.

It is also the intention to provide, with the invention, a halogen lamp in which, when operation is in the said first mode of operation or in changeover operation, the growth of whiskers on the incandescent filament, particularly in the region of the legs of the filament or the first turns of the filament, is not seen to any substantial degree during the usual working life of the lamp.

Finally, the intention is also to provide a halogen lamp that has, in its envelope, lead wires of molybdenum and in which, in operation in the above-mentioned first mode of operation or in changeover operation, any blackening of the envelope of the lamp or any deposit of layers of molybdenum and/or whiskers on the envelope of the lamp and/or on the incandescent filament is largely avoided at least during the usual working life of the lamp.

This object is achieved, as claimed in claim 1, with a halogen lamp of the kind specified in the opening paragraph that has an at least substantially bromine-free filling gas having at least one inert gas and at least one halogen in the form of chlorine.

A particular advantage of this solution lies in the fact that that the lamp can be produced at relatively low cost because, to achieve the above suitability for low lamp voltages or low lamp powers, additional constituents do not have to be introduced into the filling gas or particular materials do not have to be used for the incandescent filament or the lead wires. Hence, the achievement of the above-mentioned aim of preventing any blackening of the envelope of the lamp and any deposits, is also not dependent on the observance of special process parameters in this regard (such as, for example, additional gas constituents) during the manufacture of the lamp. Instead, the thing about which care has essentially to be taken in manufacture is that no bromine gets into the filling gas.

The dependent claims relate to advantageous refinements of the invention. Claim 2 relates to a preferred composition for the filling gas while Claim 3 describes a preferred pressure for the filling gas in the envelope of the lamp. Claim 4 describes a preferred material for the lead wires while Claims 5 and 6 relate to preferred applications for the halogen lamp according to the invention.

These and other aspects of the invention are apparent from and will be elucidated with reference to the embodiments described hereinafter.

In the drawings:

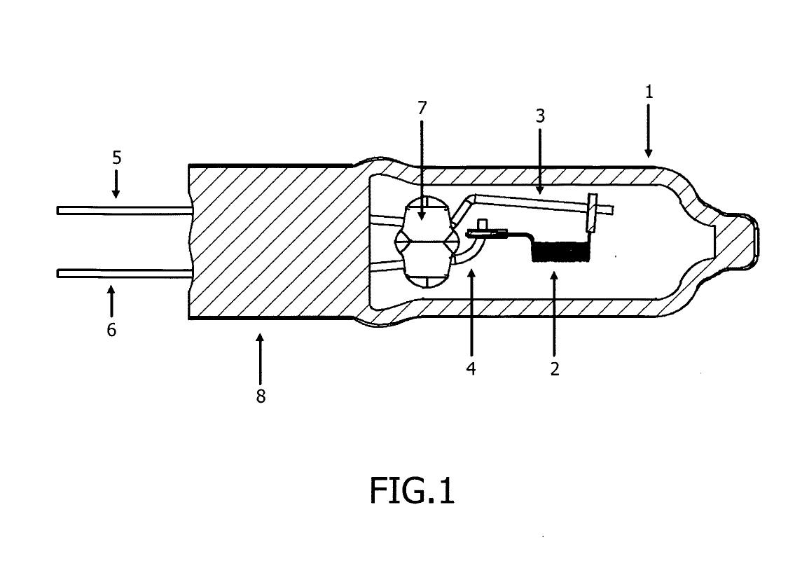

FIG. 1 is a schematic representation of a halogen lamp.

FIG. 1 shows, by way of example, a halogen lamp in longitudinal section. The lamp 1 comprises a lamp envelope 1 which is produced in a known manner from quartz glass of high temperature resistance. Situated in the interior of the lamp envelope 1 is an incandescent filament 2 that is generally composed of tungsten. The incandescent filament 2 is held between the first ends of two supply wires 3, 4 which are produced from, in essence, molybdenum.

The supply of current to the incandescent filament 2 takes place via external contact pins 5, 6 that (generally in the form of molybdenum foils) are run into the interior of the lamp envelope 1 through a pinch 8 made in the latter. The contact pins 5,6 terminate there in a quartz bridge 7 within which they are connected electrically to the second ends of the supply wires 3, 4. The contact pins 5, 6 also serve to support the quartz bridge 7 and the supply wires 3, 4 fastened thereto and the incandescent filament 2.

Situated, in accordance with the invention, in the interior of the glass envelope 1 is a bromine-free lamp-filling gas which is composed of an inert gas, such as krypton and/or xenon for example, and a halogen in the form of chlorine. In contrast to known halogen lamps, the filling gas does not contain any bromine or bromide or any mixture of bromide and chlorine.

Surprisingly, it has been found that, in this way, a cycle of the vaporization and condensation of molybdenum can be prevented, or at least suppressed to such a large extent, that, at the above-mentioned low lamp voltage or low lamp power or at a low operating temperature for the lamp, a cycle of this kind no longer causes any substantial blackening on the inside wall of the glass envelope 1 during the usual working life of the lamp (or at least during a period in operation that is substantially longer than in the case of known lamps).

The reason why this effect is surprising is because it has also been found that, particularly with H7 lamps and other similar types of lamp having a known filling gas containing bromide, the transport of molybdenum even takes place to an increased degree at a relatively low lamp voltage.

What is more, the deposit of layers of molybdenum and whiskers on the incandescent filament 2 is also at least largely prevented by the lamp-filling gas according to the invention.

A halogen lamp that is to be operated at a relatively low lamp voltage or lamp power and is to be switched between the first and second modes of operation explained above (in changeover operation) may for example contain a filling gas that has an inert gas such as krypton or xenon and chorine as a halogen, in a proportion of between approximately 100 ppm and approximately 200 ppm at a pressure for the filling gas of between approximately 5 bars and approximately 15 bars, and in particular between approximately 10 bars and approximately 15 bars.

The halogen lamp according to the invention is suitable in particular for design as an H7 lamp in compliance with known DRL requirements and in particular for operation at extremely low voltages.

Finally, one further thing that should be pointed out is that the filling gas according to the invention can of course also be used in halogen lamps of types other than that shown in FIG. 1, to enable these latter to be operated, at least for a period that is not substantially less than their usual working life, without any substantially blackening of the envelope of the lamp and/or without any substantial deposition of layers of molybdenum or whiskers.

1. A halogen lamp that is intended in particular for at least one mode of operation at a lamp voltage substantially below the nominal voltage or at a lamp power substantially below the nominal power or that is intended for switching between a first such mode of operation and a second, normal mode of operation in which the lamp is operated substantially at its nominal voltage or power, the lamp having an at least substantially bromine-free filling gas having at least one inert gas and at least one halogen in the form of chlorine.

2. A halogen lamp as claimed in claim 1, in which the filling gas comprises an inert gas and chlorine as a halogen in an amount of between approximately 100 ppm and approximately 200 ppm.

3. A halogen lamp as claimed in claim 1, in which the pressure of the filling gas in the envelope of the lamp is between approximately 10 and approximately 15 bars.

4. A halogen lamp as claimed in claim 1, in which the lead wires (3, 4) to an incandescent filament (2) are made of molybdenum.

5. A halogen lamp as claimed in claim 1, in a design for use in headlights of motor vehicles.

6. A halogen lamp as claimed in claim 5, in a design as an H7 lamp for a DRL application.
